(19) United States
(12) Patent Application Publication
(10) Pub. No.: US 2017/0094481 A1
(43) Pub. Date: Mar. 30, 2017

(54) GROUPING CONTROL METHOD OF PLAYING DEVICE, TERMINAL, AND APPARATUS

(71) Applicant: Guangdong Oppo Mobile Telecommunications Corp., Ltd., Dongguan (CN)

(72) Inventor: Shangbo Lin, Dongguan (CN)

(21) Appl. No.: 15/371,989

(22) Filed: Dec. 7, 2016

Related U.S. Application Data
(63) Continuation of application No. PCT/CN2015/097254, filed on Dec. 14, 2015.

(30) Foreign Application Priority Data
Aug. 25, 2015 (CN) 201510527461.9

(51) Int. Cl. H04W 4/08; H04W 76/02

(52) U.S. Cl. CPC H04W 4/08; H04W 76/021

(57) ABSTRACT

The present disclosure includes a grouping control method of a playing device, a terminal, and an apparatus. The method includes: receiving a grouping command for adding a target playing device in a playing device list to a target group; responding to the grouping command and detecting a working state of the target playing device; and adding the target playing device to the target group according to the working state.

### CROSS-REFERENCE TO RELATED APPLICATIONS

This application is a continuation of International Application No. PCT/CN2015/097254, filed on Dec. 14, 2015, which claims the priority of Chinese patent application No.201510527461.9, filed on Aug. 25, 2015, the disclosures of both of which are herein incorporated by reference in their entireties.

### TECHNICAL FIELD

The present disclosure relates to communication technology field, and particularly, to a grouping control method of a playing device and a terminal.

### BACKGROUND

With the development of Internet technology and playing device, a wireless music system including a plurality of playing devices is becoming more and more popular. To facilitate users to control multiple playing devices within the wireless music system to perform the same operation synchronously, the playing devices can be grouped by user, and the playing devices required to perform the same operation will be divided into one group. The user can control all playing devices of a group by controlling the group, and it is convenient for the user to control the playing device.

### SUMMARY

Disclosed herein are implementations of a grouping control method of a playing device, comprising receiving a grouping command for adding a target playing device in a playing device list to a target group, responding to the grouping command and detecting a working state of the target playing device, and adding the target playing device to the target group according to the working state.

Disclosed herein are also implementations of a terminal, comprising a first receiving unit, configured to receive a grouping command for adding a target playing device in a playing device list to a target group, a detecting unit, configured to respond to the grouping command and detect a working state of the target playing device, and a grouping unit, configured to add the target playing device to the target group according to the working state.

Disclosed herein are also implementations of an apparatus, comprising one or more processors, and a memory comprising program codes, wherein when executed by the one or more processors, the program codes are adapted to cause the one or more processors to execute the following program units: a first receiving unit, configured to receive a grouping command for adding a target playing device to a target group, a first detecting unit, configured to respond to the grouping command and detect a working state of the target playing device, and a grouping unit, configured to add the target playing device to the target group according to the working state.

### BRIEF DESCRIPTION OF THE DRAWINGS

The above mentioned and/or other aspects and advantages of the present disclosure will become clear and easy to understand from the implementations described in conjunction with the accompanying drawings.

FIG. 1 is a schematic diagram illustrating system architecture according to an implementation of the present disclosure;

FIG. 2 is a flowchart illustrating a grouping control method of a playing device according to an implementation of the present disclosure;

FIG. 3 is a flowchart illustrating another grouping control method of a playing device according to an implementation of the present disclosure;

FIG. 4 is a structure schematic diagram illustrating a terminal according to an implementation of the present disclosure;

FIG. 5 is a structure schematic diagram illustrating another terminal according to an implementation of the present disclosure;

FIG. 6 is a structure schematic diagram illustrating another terminal according to an implementation of the present disclosure;

FIG. 7 is a structure schematic diagram illustrating another terminal according to an implementation of the present disclosure; and

FIG. 8 is a block diagram illustrating an apparatus of an implementation of the present disclosure.

### DETAILED DESCRIPTION

Technical solutions of the implementations of the present disclosure will now be described clearly and completely taken in conjunction with the accompanying drawings; it will be apparent to one of ordinary skill in the art that, the implementations described below are merely a part of the disclosure and other implementations obtained out of them without creative work will fall into the protection scope of the present disclosure either.

Implementations of the present disclosure relate to a grouping control method of a playing device and a terminal, through which a playing device can be grouped according to the working state thereof flexibly. It is hereinafter described in detail.

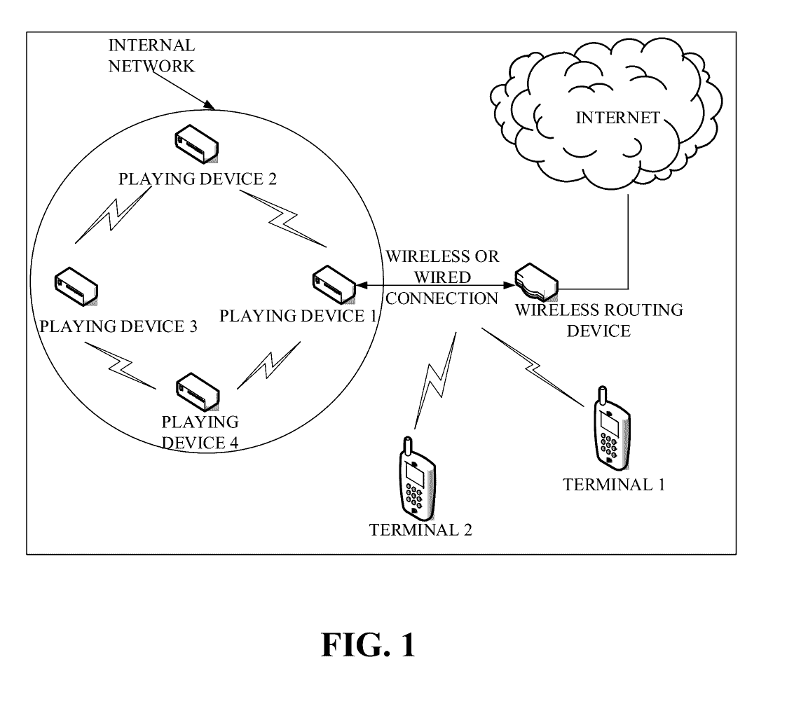

FIG. 1 is a schematic diagram of system architecture according to an implementation of the present disclosure. As illustrated in FIG. 1, the system architecture may include a plurality of playing devices, a wireless routing device, and a plurality of terminals (can be referred to as user terminal), among which the playing device may include but not limited to a speaker, MP4, MP3, multimedia device or any playing function enabled device; the wireless routing device may include but not limited to a wireless router or any wireless coverage function enabled device; the terminal may include smart phone, tablet PC, laptop computer, handheld computer, mobile Internet device (MID) or other smart devices. In the system architecture illustrated in FIG. 1, communication connection among playing devices is established in a wireless manner (such as AD-HOC network form or MESH network form). Among these playing devices, there is a main playing device (such as Playing device 1) which can establish connection with the wireless routing device in a wireless or wired manner. After connecting with the wireless routing device, a control application installed terminal can control the main playing device and then further control other playing devices via the main playing device to play.

### Implementation 1

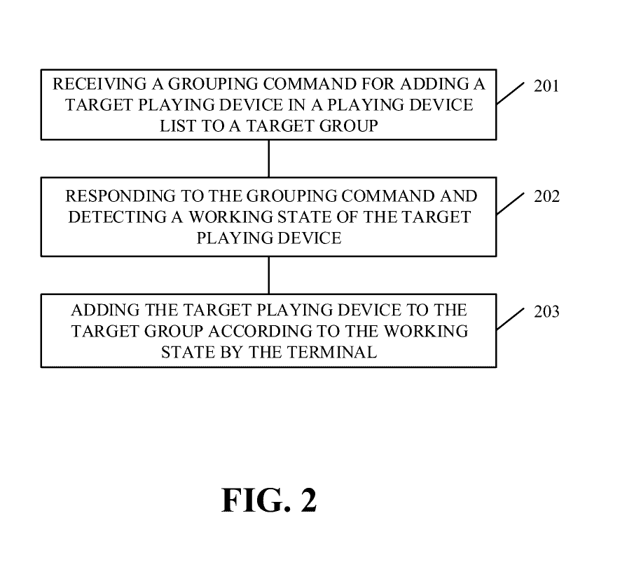

Based on the system architecture illustrated in FIG. 1, a grouping control method of a playing device is provided according to an implementation of the present disclosure. FIG. 2 is a flowchart illustrating the grouping control method. As illustrated in FIG. 2, the grouping control method can begin at block 201 and can be performed by a terminal (can be referred to as user terminal either).

At block 201, a terminal receives a grouping command; the grouping command is configured to require adding a target playing device in a playing device list into a target group.

In at least one implementation of the present disclosure, the terminal can include but not limited to smart phone, handheld computer (PDA), laptop computer, desktop computer, and the like. The operating system of the terminal can include but not limited to Android operating system, IOS operating system, Symbian operating system, BlackBerry operating system, Windows Phone 8 operating system and the like. The present disclosure is not limited thereto.

As one implementation, a user can deploy multiple playing devices at home arbitrarily. For example, these playing devices can be placed in different rooms, for instance, Playing device 1 and Playing device 2 are placed in a living room; Playing device 3 is placed in a bedroom; Playing device 4 is placed in a study room. These playing devices establish a communication connection among each other via a wireless manner (such as AD-HOC network form or MESH network form) to form an internal network. According to implementations of the present disclosure, the playing device list includes all playing devices searched by the terminal within the internal network. The user can select one or more playing devices from the playing device list to conduct grouping operation.

In this implementation, the target playing device can be any playing device in the playing device list, and the present disclosure is not limited thereto.

At block 202, the terminal responds to the grouping command, and detects a working state of the target playing device.

After the grouping command is received, the terminal will respond to the grouping command and detect the working state of the target playing device. Wherein the working state can include but not limited to a standby state, a playing state, a disconnection state and so on, the present disclosure is not limited thereto. If the playing device is in the standby state, no operation will be performed and systems and all hardware of the playing device are turned off, and the device will wait for a start command. The playing device will be in the playing state if a multimedia file is being played. The playing device will be in the disconnection state if no connection is established with a terminal.

At block 203, the terminal adds the target playing device to the target group according to the working state.

In one implementation, the terminal can set grouping rules corresponding to different working states in advance. After obtaining the working state of the target playing device, the terminal will perform grouping operation on the target playing device in accordance with a grouping rule corresponding to the working state of the target playing device, and it will be described in detail below.

### EXAMPLE 1

As an example, the working state is the standby state. The process of adding the target playing device to the target group according to the working state can be implemented as follows.

11) If the working state is the standby state, the terminal adds the target playing device to the target group.

That is to say, if it is detected that the working state of the target playing device is the standby state, the terminal will add the target playing device to the target group directly.

Optionally, after adding the target playing device to the target group, the terminal can further perform the following process.

12) A start command is sent to the target playing device so as to start the target playing device.

In this example, if the target playing device is the main playing device, the terminal will send the start command to the target playing device directly; if the target playing device is not the main playing device, the terminal will send the start command to the main playing device, such that the main playing device can transfer the start command to the target playing device.

After receiving the start command, the target playing device will respond to the start command and start the closed system and hardware to enter into a start state.

In practical application, after grouping is performed on the playing device, the terminal will use the playing device of a group to play multimedia files immediately. After a playing device in the standby state is added to the group, if the user wants to control the playing device in the standby state to play the multimedia files, the user has to start the playing device in the standby state manually, and then the playing device can be controlled after starting. Obviously, it is not easy for the user to conduct playing device control quickly. In this implementation, by sending the start command to the target playing device after the target playing device in the standby state has been added to the target group, the target playing device can enter into the start state, thus avoiding the user to start a standby playing device manually and the user can control the target playing device quickly. As a result, it is convenient for the user to control the playing device, and the user experience can be improved.

### EXAMPLE 2

As an example, the working state is the playing state. The process of adding the target playing device to the target group according to the working state can be implemented as follows.

21) The terminal will detect whether the terminal per se is a control terminal that controls the target playing device to play.

22) If the terminal per se is the control terminal, it will add the target playing device to the target group.

In the implementation, within a network, any terminal connected with the target playing device can control the target playing device to play. But at the same time point, only one terminal is capable of controlling the target playing device.

In the implementation, if it is detected that the working state of the target playing device is the playing state, the terminal will detect whether the terminal per se is the control terminal that controls the target playing device to play. If the terminal is the control terminal, it will add the target playing device to the target group; otherwise, if the terminal is not the control terminal, it will be prohibited to add the target playing device to the target group.

In practical application, suppose Terminal A is controlling the target playing device to play; after the target playing device is added to the target group by Terminal B, control on the target playing device by Terminal A will be interrupted if Terminal B attempts to control the target playing device in the target group for playing, and as a result, user experience will be affected. With aid of the technical schemes of the present disclosure, the terminal will add the target playing device to the target group only if it is detected that the terminal per se is the control terminal that currently controls the target playing device to play, it helps to reduce the probability of control conflict and improve the user experience.

### EXAMPLE 3

As another example, the working state is the disconnection state. The process of adding the target playing device to the target group according to the working state can be implemented as follows.

31) The terminal will send a connection request to the target playing device.

32) Upon receiving a connection permit command sent from the target playing device in response to the connection request, the terminal will establish a connection with the target playing device and add the target playing device to the target group.

In this example, if it is detected that the working state of the target playing device is the disconnection state, the terminal will send the connection request to the target playing device; after receiving the connection permit command sent from the target playing device in response to the connection request, the terminal will establish a connection with the target playing device according to the connection permit command, and add the target playing device to the target group.

As one implementation, if the working state is the disconnection state, the terminal can add the target playing device to the target group first, and then send the connection request to the target playing device to establish a connection therewith.

In practice, after grouping is performed on the playing device, the terminal will use the playing device of a group to play multimedia files immediately. After a playing device in the disconnect state is added to the group, if the user wants to control the playing device in the disconnected state to play the multimedia files, the user has to connect the playing device in the disconnected state manually. Obviously, it is not convenient for the user to quickly control the playing device. In this example, by connecting the target playing device automatically before grouping, manual connection of the playing device by user can be avoided, thus, the user can control the target playing device quickly. The technical schemes of the present disclosure provide the user with convenience to control the playing device, and the user experience can be improved.

In the method as illustrated in FIG. 2, after receiving the grouping command requiring adding the target playing device in the playing device list to the target group, the terminal will respond to the grouping command and detect the working state of the target playing device and add the target playing device to the target group according to the working state. Therefore, it is possible for the terminal to perform grouping operation on the playing device flexibly according to the working state thereof.

### Implementation 2

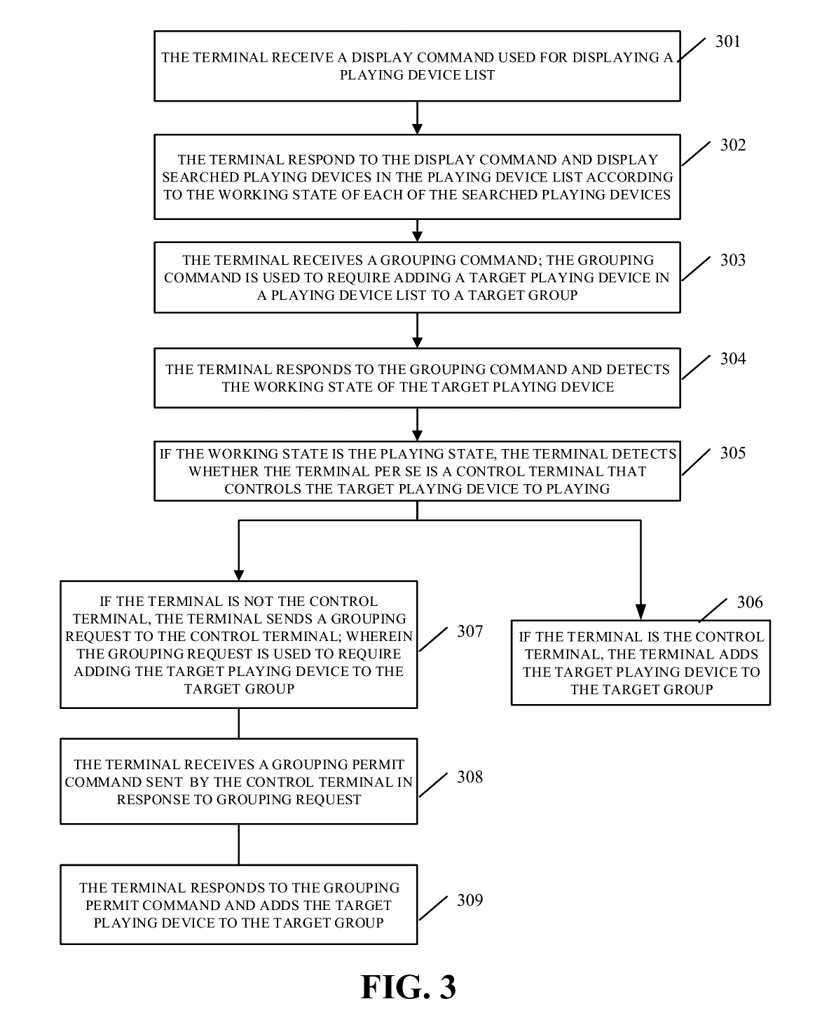

Based on the system architecture illustrated in FIG. 1, the present disclosure provides another grouping control method of a playing device. FIG. 3 is a flowchart illustrating the grouping control method. As illustrated in FIG. 3, the grouping control method can begin at block 301.

At block 301, the terminal receives a display command for displaying a playing device list.

In this implementation, when a user wants to perform grouping operation on a playing device(s), the user can open the playing device list and select one or more playing devices to be grouped from the playing device list. As one implementation, in order to input the display command, the user can click a function button provided on the terminal, wherein the function button is configured to display the playing device list. As another implementation, the terminal can detect a touch operation of the user at a touch area, if the terminal detects that a multi-touch operation is performed for a preset number of times at the touch area by user, the terminal will be triggered to receive the display command configured to display the playing device list.

At block 302, the terminal responds to the display command, searches playing devices within the network and detects the working state of each playing device, and displays searched playing devices in the playing device list according to the working state of each of the searched playing devices.

The working state may include but not limited to a standby state, a playing state, a disconnection state, and so on, the present disclosure is not limited thereto. After obtaining the working state of each playing device, the terminal will display each playing device according to the working state thereof respectively. For example, suppose Playing device land Playing device 2 are in the playing state, Playing device 3 and Playing device 4 are in the standby state, then the terminal can display icons of Playing device 1 and Playing device 2 in the same color and prompt that Playing device 1 and Playing device 2 are in the playing state; similarly, the terminal can display icons of Playing device 3 and Playing device 4 in another same color and prompt that Playing device 3 and Playing device 4 are in the playing state. By displaying each playing device according to the working state respectively in the playing device list, the user can know the working state of each playing device in the playing device list quickly, and it is convenient for the user to control various playing devices.

At block 303, the terminal receives a grouping command; the grouping command is configured to require adding a target playing device in a playing device list into a target group.

In one implementation of the present disclosure, the target playing device can be any playing device in the playing device list. After the terminal displaying the playing devices according to their working state, the user can choose one or more playing devices from the playing device list to perform grouping operation.

At block 304, the terminal responds to the grouping command and detects the working state of the target playing device. As one implementation, if the time interval between the process of block 302 and 304 is sufficiently small, such as less than a predetermined time threshold in a magnitude of second or millisecond, at block 304, the terminal can read or acquire the working state of the target playing device from the playing device list directly, and there's no need to perform detection again.

At block 305, if the working state is the playing state, the terminal detects whether the terminal per se is a control terminal that controls the target playing device to play.

At block 306, if the terminal is the control terminal, the terminal adds the target playing device to the target group.

At block 307, if the terminal is not the control terminal, the terminal sends a grouping request to the control terminal; wherein the grouping request is configured to require adding the target playing device to the target group.

As one implementation, if the terminal per se is not the control terminal, the terminal can send a terminal ID (identification) acquisition command to the target playing device. If the target playing device is not the main playing device, the terminal can send the terminal ID acquisition command to the main playing device such that the main playing device can transfer the terminal ID acquisition command to the target playing device. After receiving the terminal ID acquisition command, the target playing device will acquire the ID information of the control terminal that currently controls the target playing device to play, and send the ID information to the main playing device, such that the main playing device can transmit the ID information to the terminal. After receiving the ID information, the terminal will send the grouping request to the control terminal according to the ID information. The ID information may be a MAC address, an IP address, and the like of the terminal, the present disclosure is not limited thereto.

As another implementation, the terminal can also send the terminal ID acquisition command via a cloud server in order to obtain ID information of the control terminal. After the terminal ID acquisition command is received, the cloud server will respond to the command and obtain the ID information of the control terminal that currently controls the target playing device to play and return the ID information obtained to the terminal.

At block 308, the terminal receives a grouping permit command sent by the control terminal in response to grouping request.

In this implementation, after receiving the grouping request sent by the terminal, the control terminal will output prompt information for prompting the user of whether the terminal is allowed to add the target playing device into the target group. If the control terminal receives a confirmation that input in response to the prompt information by user, it will send the grouping permit command to the terminal.

At block 309, the terminal responds to the grouping permit command and adds the target playing device to the target group.

As can be seen in this implementation, the terminal can add the target playing device to the target group according to the grouping permit command received.

In practice, the user of the terminal may have an urgent need for some reason to perform grouping operation on the target playing device; through the implementation of the implementation depicted in FIG. 3, if the terminal detects that the control terminal is controlling the target playing device to play, the terminal will send the grouping request to the control terminal and add the target playing device to the target group if grouping is authorized by the control terminal, whereby success rate of grouping by the terminal is improved and the process is more personalized.

### Implementation 3

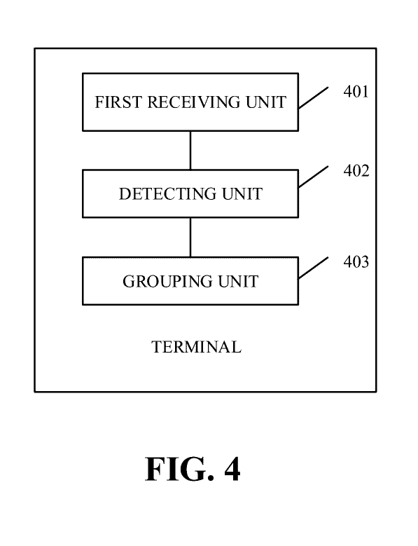

Based on the system architecture illustrated in FIG. 1, a terminal is provided according to an implementation of the present disclosure. FIG. 4 is a structure schematic diagram illustrating the terminal. As illustrated in FIG. 4, the terminal can include a first receiving unit 401(for example, can be a receiver), a detecting unit 402 (for example, can be a detector), and a grouping unit 403 (for example, can be a processor).

The first receiving unit 401 is configured to receive a grouping command for adding a target playing device in a playing device list to a target group.

In at least one implementation, the terminal can include but not limited to smart phone, handheld computer (PDA), laptop computer, desktop computer, and the like. The operating system of the terminal can include but not limited to Android operating system, IOS operating system, Symbian operating system, BlackBerry operating system, Windows Phone8 operating system, and the like. The present disclosure is not limited thereto.

As one implementation, a user can deploy multiple playing devices at home arbitrarily. For example, these playing devices can be placed in different rooms, for instance, Playing device 1 and Playing device 2 are placed in a living room; Playing device 3 is placed in a bedroom; Playing device 4 is placed in a study room. These playing devices establish a communication connection among each other via a wireless manner (such as AD-HOC network form or MESH network form) to form an internal network. According to implementations of the present disclosure, the playing device list includes all playing devices searched by the terminal within the internal network. The user can select one or more playing devices from the playing device list to conduct grouping operation.

In this implementation, the target playing device can be any playing device in the playing device list, and the present disclosure is not limited thereto.

The detecting unit 402 is configured to respond to the grouping command and detect a working state of the target playing device.

After the grouping command is received by the first receiving unit 401, the detecting unit 402 will respond to the grouping command and detect the working state of the target playing device. Wherein the working state can include but not limited to a standby state, a playing state, a disconnection state (in other words, disconnection state) and so on, the present disclosure is not limited thereto. If the playing device is in the standby state, no operation will be performed and systems and all hardware of the playing device are turned off, and device will wait for a start command. The playing device will be in the playing state if a multimedia file is being played. The playing device will be in the disconnection state if no connection is established with a terminal.

The grouping unit 403 is configured to add the target playing device to the target group according to the working state.

In one implementation, the terminal can set grouping rules corresponding to different working states in advance. After obtaining the working state of the target playing device by the detecting unit 402, the grouping unit 403 will perform grouping operation on the target playing device in accordance with a grouping rule corresponding to the working state of the target playing device.

### Implementation 4

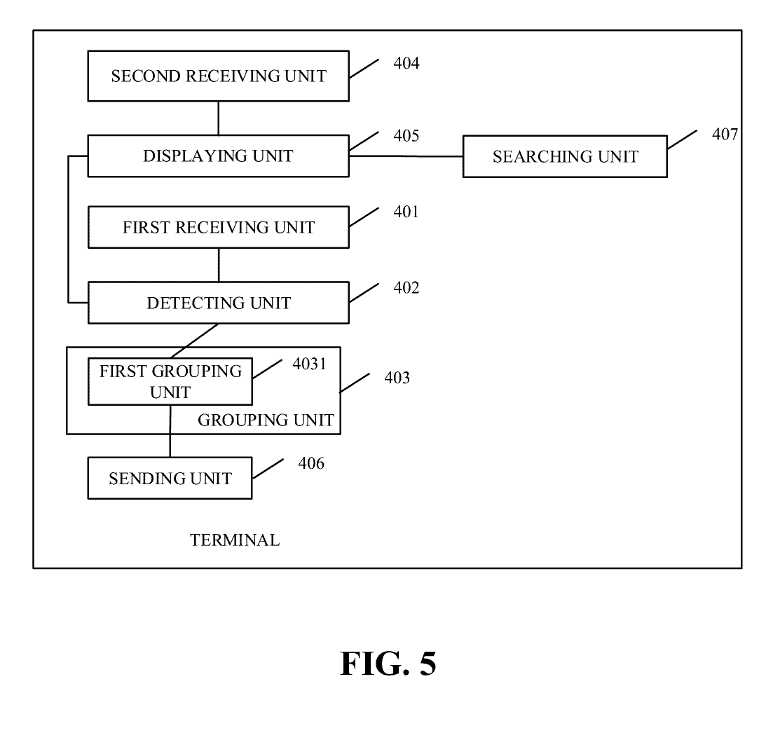

Further refer to FIG. 5, which is a structure schematic diagram illustrating another terminal according to an implementation. Compared with the terminal of FIG. 4, in addition to all of the units illustrated in FIG. 4, the terminal illustrated in FIG. 5 further includes a second receiving unit 404 (for example, can be a receiver), a displaying unit 405 (such as a display), a searching unit 407, and a sending unit 406 (such as a transmitter); moreover, the grouping unit 403 includes a first grouping unit 4031 (such as a processor).

The second receiving unit 404 is configured to receive a display command for displaying the playing device list, before the grouping command is received by the first receiving unit 401, wherein the grouping command is configured to add the target playing device in the playing device list to the target group.

In this implementation, when a user wants to perform grouping operation on a playing device(s), the user can open the playing device list and select one or more playing devices to be grouped from the playing device list. As one implementation, in order to input the display command, the user can click a function button, which is configured to display the playing device list, provided on the terminal. As another implementation, the terminal can detect a touch operation of the user at a touch area, if the terminal detects that a multi-touch operation is performed for a preset number of times at the touch area by user, the second receiving unit 404 will be triggered to receive the display command configured to display the playing device list.

The displaying unit 405 is configured to respond to the display command and display playing devices searched by the searching unit 407 in the playing device list according to the working state of each of the searched playing devices.

In this implementation, after the display command is received by the second receiving unit 404, the searching unit 407 will respond to the display command and search playing devices within the network and the detecting unit 402 will detect the working state of each playing device. The working state may include but not limited to a standby state, a playing state, a disconnection state and so on, the present disclosure is not limited thereto. After the detecting unit 402 obtaining the working state of each playing device, the displaying unit 405 will display each playing device according to the working state thereof. For example, suppose Playing device 1 and Playing device 2 are in the playing state, Playing device 3 and Playing device 4 are in the standby state, then the displaying unit 405 can display icons of Playing device 1 and Playing device 2 in the same color and prompt that Playing device 1 and Playing device 2 are in the playing state; similarly, the displaying unit 405 can display icons of Playing device 3 and Playing device 4 in another same color and prompt that Playing device 3 and Playing device 4 are in the playing state. By displaying each playing device in the playing device list according to the working state respectively, the user can know the working state of each playing device in the playing device list more quickly, and it is convenient for the user to control various playing devices.

The first grouping unit 4031 is configured to add the target playing device to the target group if the working state of the target playing device is the standby state.

In one implementation of the present disclosure, if the detecting unit 402 detects that the working state of the target playing device is the standby state, the first grouping unit 4031 can add the target playing device to the target group directly.

The sending unit 406 is configured to send a start command to the target playing device so as to start the target playing device, after the target playing device in the standby state has been added to the target group by the first grouping unit 4031.

In the implementation of the present disclosure, if the target playing device is the main playing device, the sending unit 406 can sent the start command directly to the target playing device; if the target playing device is not the main playing device, the sending unit 406 can send the start command to the main playing device such that the main playing device can transfer the start command to the target playing device.

According to the implementation of the present disclosure, after the start command is received, the target playing device will respond to the command and start the closed system and hardware to enter into a start state.

In practice, after grouping is performed on the playing device, the terminal will use the playing device of a group to play multimedia files immediately. After a playing device in the standby state is added to the group, if the user wants to control the playing device in the standby state to play the multimedia files, the user has to start the playing device in the standby state manually, and then the playing device can be controlled after starting. Obviously, it is not easy for the user to conduct playing device control quickly. In this implementation, by sending the start command to the target playing device after the target playing device in the standby state has been added to the target group, the target playing device can enter into the start state, thus avoiding the user to start a standby playing device manually and the user can control the target playing device quickly. As a result, it is convenient for the user to control the playing device, and the user experience can be improved.

### Implementation 5

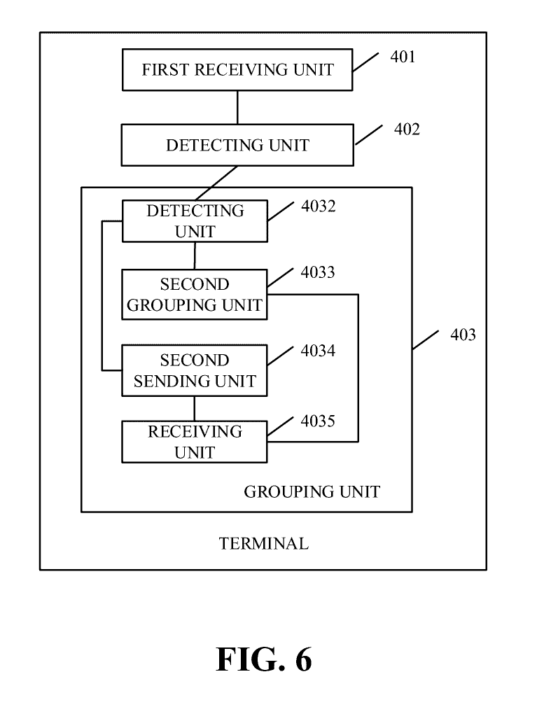

Further refer to FIG. 6, which is a structure schematic diagram illustrating another terminal according to an implementation of the present disclosure. Compared with the terminal of FIG. 4, the terminal illustrated in FIG. 6 includes all of the units illustrated in FIG. 4, and the grouping unit 403 further includes a detecting unit 4032 (such as a detector), a second grouping unit 4033 (such as a processor), a second sending unit 4034 (such as a transmitter), and a receiving unit 4035 (for example, a receiver).

The detecting unit 4032 is configured to detect whether the terminal per se is a control terminal that controls the target playing device to play if the working state is a playing state.

The second grouping unit 4033 is configured to add the target playing device to the target group if it is detected by the detecting unit 4032 that the terminal is the control terminal.

In the implementation of the present disclosure, in the network, any terminal connecting with the target playing device can control the target playing device to play. However, only one terminal can control the target playing device at the same time point.

As an implementation, the detecting unit 4032 will detect whether the terminal is the control terminal that currently controls the target playing device to play if it is detected that the working state of the target playing device is the playing state. If the terminal is the control terminal, the second grouping unit 4033 can add the target playing device to the target group. Otherwise, if the terminal is not the control terminal, the second sending unit 4034 can send a grouping request to the control terminal, wherein the grouping request is configured to require adding the target playing device to the target group.

As one implementation, if the terminal per se is not the control terminal, the terminal can send a terminal ID (identification) acquisition command to the target playing device. If the target playing device is not the main playing device, the terminal can send the terminal ID acquisition command to the main playing device such that the main playing device can transfer the terminal ID acquisition command to the target playing device. After receiving the terminal ID acquisition command, the target playing device will acquire the ID information of the control terminal that currently controls the target playing device to play, and send the ID information to the main playing device, such that the main playing device can transmit the ID information to the terminal. After receiving the ID information, the second sending unit 4034 will send the grouping request to the control terminal according to the ID information. The ID information may be a MAC address, IP address, and the like of the terminal, the present disclosure is not limited thereto.

As another implementation, the terminal can also send the terminal ID acquisition command via a cloud server in order to obtain ID information of the control terminal. The cloud server will respond to the terminal ID acquisition command received and obtain the ID information of the control terminal that currently controls the target playing device to play, and return the ID information obtained to the terminal.

The receiving unit 4035 is configured to receive a grouping permit command sent by the control terminal in response to grouping request.

In this implementation, after receiving the grouping request sent by the terminal, the control terminal will output prompt information for prompting the user of whether the terminal is allowed to add the target playing device to the target group. If the control terminal receives a confirmation that input in response to the prompt information by user, it will send the grouping permit command to the terminal.

The second grouping unit 4033 is further configured to add the target playing device to the target group according to the grouping permit command.

As can be seen in this implementation, the second grouping unit 4033 can add the target playing device to the target group according to the grouping permit command after the command is received by the receiving unit 4035.

In practical application, suppose Terminal A is controlling the target playing device to play; after the target playing device is added to the target group by Terminal B, control on the target playing device by Terminal A will be interrupted if Terminal B attempts to control the target playing devices in the target group for playing, and as a result, user experience will be affected. With aid of the technical scheme of the present disclosure, the terminal will add the target playing device to the target group only if it is detected that the terminal per se is the control terminal that currently controls the target playing device to play, it helps to reduce the probability of control conflict and improve the user experience.

### Implementation 6

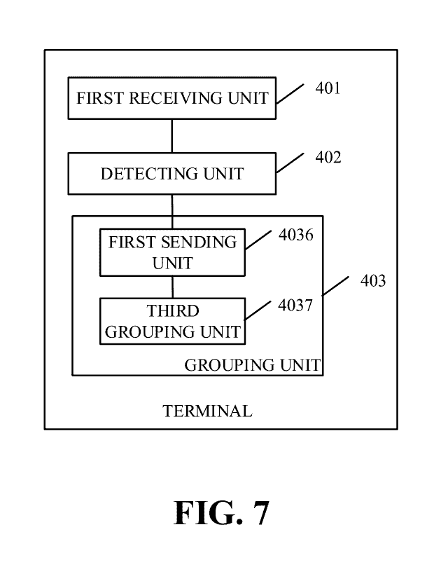

Further refer to FIG. 7, which is a structure schematic diagram illustrating another terminal according to an implementation of the present disclosure. Compared with the terminal of FIG. 4, the terminal illustrated in FIG. 7 includes all of the units illustrated in FIG. 4, and the grouping unit 403 further includes a first sending unit 4036 (for example, a transmitter) and a third grouping unit 4037 (for example, a processor).

The first sending unit 4036 is configured to send a connection request to the target playing device if the working state is the disconnection state.

The third grouping unit 4037 is configured to establish a connection with the target playing device and add the target playing device to the target group upon receiving a connection permit command sent by the target playing device in response to the connection request.

As can be seen from the implementation, if the detecting unit 402 detects that the target playing device is in the disconnection state, the first sending unit 4036 will send the connection request to the target playing device; after receiving the connection permit command sent by the target playing device in response to the connection request, the third grouping unit 4037 can establish a connection with the target playing device according to the connection permit command, and add the target playing device to the target group.

As one implementation, if the working state is the disconnection state, the terminal can add the target playing device to the target group first, and then send the connection request to the target playing device to establish a connection therewith.

In practice, after grouping is performed on the playing device, the terminal will use the playing device of a group to play multimedia files immediately. After a playing device in the disconnect state is added to the group, if the user wants to control the playing device in the disconnected state to play the multimedia files, the user has to connect the playing device in the disconnected state manually, and then the playing device can be controlled after starting. Obviously, it is not convenient for the user to quickly control the playing device. In this example, by connecting the target playing device automatically before grouping, manual connection of the playing device by the user can be avoided, thus, the user can control the target playing device quickly. The technical schemes of the present disclosure provide the user with convenience to control the playing device, and the user experience can be improved.

In the terminal illustrated in FIG. 4 to FIG. 7, the first receiving unit is configured to receive the grouping command for adding the target playing device in the playing device list to the target group; the detecting unit is configured to respond to the grouping command and detect the working state of the target playing device; the grouping unit is configured to add the target playing device to the target group according to the working state of the target playing device. It can be seen that via technical schemes of the implementations of the present disclosure, it is possible for the terminal to perform grouping operation on the playing device according to the working state flexibly. As can be seen from above, the same component uses the same reference number throughout the description.

It should be noted that, for each method of the aforementioned implementations, for ease of description, it has been referred to as a combination of a series of actions, those skilled in the art should be aware that this disclosure is not restricted by the sequence of the actions, in contrast, some steps can be performed in other sequence or simultaneously. In addition, those skilled in the art should also be aware that the implementations described herein are exemplary implementations only, operations and units involved are not necessarily for the implementation of the present disclosure.

### Implementation 7

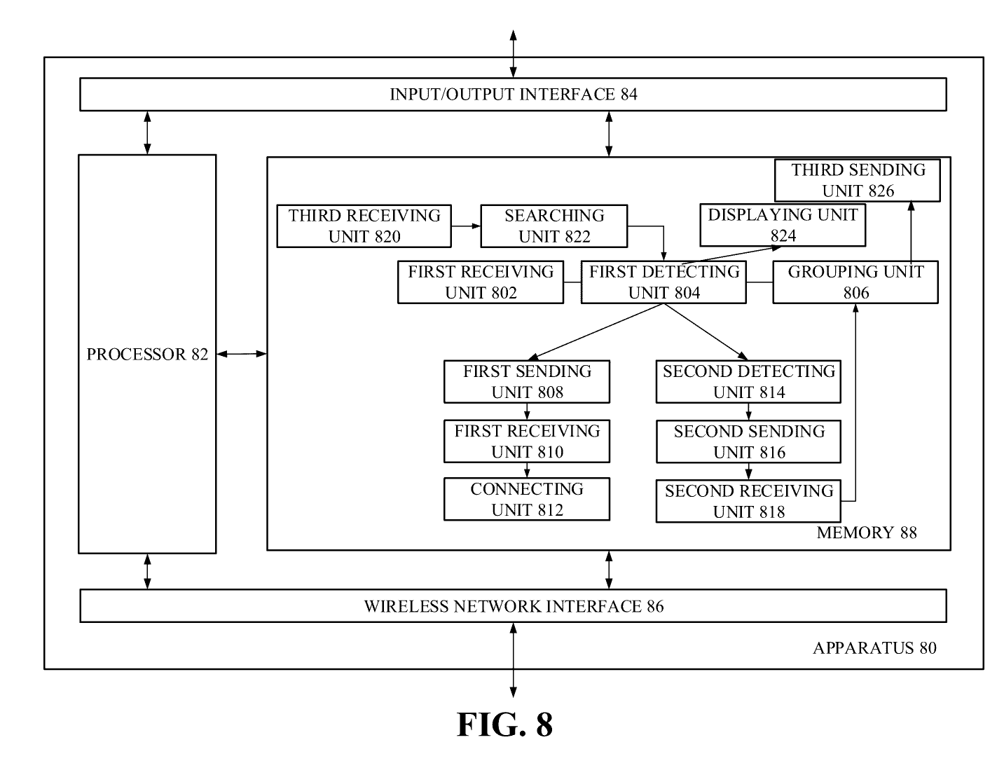

According to another implementation of the present disclosure, it is provided an apparatus. FIG. 8 is a block diagram illustrating the apparatus.

As illustrated in FIG. 8, the apparatus a memory 88, one or more processors 82 (for ease of explanation, only one is illustrated in the FIG. 8), an Input/output interface 84 and a wireless network interface 86, through which the apparatus can communicate with other equipments. Those well-known elements such as display, operating system and so on are not illustrated. The apparatus will be described in detail below with refer to the drawings.

The memory is configured to store program codes, when executed by the one or more processors, the program codes are adapted to cause the processors to execute the following program units as illustrated in FIG. 8.

A first receiving unit 802, configured to receive a grouping command for adding a target playing device to a target group.

A first detecting unit 804, configured to respond to the grouping command received by the first receiving unit 802 and detect a working state of the target playing device.

A grouping unit 806, configured to add the target playing device to the target group according to the working state detected by the first detecting unit 804.

The working state includes a standby state, a playing state, and a disconnection state, for example, which will be described in detail respectively.

1. The working state is the standby state.

In this case, the grouping unit 806 will be executed directly to add the target playing device to the target group.

After adding the target playing device to the target group, the third sending unit 826 can send a start command to the target playing device to start it.

2. The working state is the playing state.

In this case, the processor will execute a second detecting unit 814 to detect whether the terminal is a control terminal that controls the target playing device to play.

If the terminal is not the control terminal, as detected by the second detecting unit 814, the processor will execute a second sending unit 816 to send a grouping request to the control terminal so as to require adding the target playing device to the target group, and the processor will execute a second receiving unit 818 to receive a grouping permit command sent by the control terminal in response to the grouping request.

In response to the grouping permit command received by the second receiving unit 818, the grouping unit 806 will be executed to add the target playing device to the target group.

3. The working state is the disconnection state.

In this case, the processor will execute a first sending unit 808 to send a connection request to the target playing device, execute a first receiving unit 810 to receive a connection permit command sent by the target playing device in response to the connection request, and execute a connecting unit 812 to establish a connection with the target playing device according to the connection permit command received by the first receiving unit.

In response to the connection permit command received by the first receiving unit 810, the grouping unit 806 will be executed to add the target playing device to the target group.

As one implementation, when executed by the processor 82, the program code stored in the memory 88 further adapted to execute the following program units: a third receiving unit 820, configured to receive a display command for displaying the playing device list, before the grouping command is received by the first receiving unit 802; a searching unit 822, configured to search playing devices within a network; and a displaying unit 824, configured to respond to the display command and display searched playing devices in the playing device list according to a first working state of each of the searched playing devices. In this case, the first detecting unit will be executed to detect a first working sate of each of the playing devices searched by the searching unit.

Steps of the method of the present disclosure can be sequential adjusted, combined, or deleted according to actual needs. Modules or units of the terminal of the present disclosure can be combined, divided, and deleted according to actual needs.

Those skilled in the art should be appreciated that all or part of the steps in the above-described method implementations can be completed through hardware related equipments which are instructed via a program, the program may be stored in a machine-readable storage medium, among which the storage medium may include flash disk, read only memory (ROM), random access memory (RAM), magnetic disk or CD.

The foregoing descriptions are merely preferred implementations of the present disclosure, rather than limiting the present disclosure. Various modifications and alterations may be made to the present disclosure for those skilled in the art. Any modification, equivalent substitution, improvement or the like made within the spirit and principle of the present disclosure shall fall into the protection scope of the present disclosure.

What is claimed is:

1. A grouping control method of a playing device, comprising:
receiving a grouping command for adding a target playing device in a playing device list to a target group;
responding to the grouping command and detecting a working state of the target playing device; and
adding the target playing device to the target group according to the working state.

2. The method of claim 1, wherein the working state is a standby state, and adding the target playing device to the target group according to the working state comprises:
adding the target playing device to the target group.

3. The method of claim 1, wherein the working state is a playing state, and adding the target playing device to the target group according to the working state comprises:
detecting whether a terminal is a control terminal that controls the target playing device to play; and
adding the target playing device to the target group when the terminal is the control terminal.

4. The method of claim 1, wherein the working state is a disconnection state, and adding the target playing device to the target group according to the working state comprises:
sending a connection request to the target playing device;
establishing a connection with the target playing device; and
adding the target playing device to the target group upon receiving a connection permit command sent by the target playing device in response to the connection request.

5. The method of claim 2, wherein after adding the target playing device to the target group, the method further comprises:
sending a start command to the target playing device to start the target playing device.

6. The method of claim 3, further comprising:
sending a grouping request to the control terminal to require adding the target playing device to the target group, when the terminal is not the control terminal;
receiving a grouping permit command sent by the control terminal in response to the grouping request; and
adding the target playing device to the target group according to the grouping permit command.

7. The method of claim 1, wherein before receiving the grouping command, the method further comprises:
receiving a display command for displaying the playing device list;
responding to the display command, and searching playing devices in a network;
detecting a first working state of each of the playing devices; and
displaying the playing devices in the playing device list according to the first working state of each of the searched playing devices.

8. A terminal, comprising:
a first receiving unit, configured to receive a grouping command for adding a target playing device in a playing device list to a target group;
a detecting unit, configured to respond to the grouping command and detect a working state of the target playing device; and
a grouping unit, configured to add the target playing device to the target group according to the working state.

9. The terminal of claim 8, wherein the grouping unit comprises:
a first grouping unit, configured to add the target playing device to the target group when the working state is a standby state.

10. The terminal of claim 8, wherein the grouping unit comprises:
a detecting unit, configured to detect whether the terminal is a control terminal that controls the target playing device to play when the working state is a playing state; and
a second grouping unit, configured to add the target playing device to the target group when it is detected by the detecting unit that the terminal is the control terminal.

11. The terminal of claim 8, wherein the grouping unit comprises:
a first sending unit, configured to send a connection request to the target playing device when the working state is a disconnection state; and
a third grouping unit, configured to establish a connection between the terminal and the target playing device and add the target playing device to the target group upon receiving a connection permit command sent by the target playing device in response to the connection request.

12. The terminal of claim 9, further comprising:
a sending unit, configured to send a start command to the target playing device to start the target playing device, after the target playing device in the standby state is added to the target group by the first grouping unit.

13. The terminal of claim 10, wherein the grouping unit further comprises:
a second sending unit, configured to send a grouping request to the control terminal to require adding the target playing device to the target group, when it is detected by the detecting unit that the terminal is not the control terminal; and
a receiving unit, configured to receive a grouping permit command sent by the control terminal in response to the grouping request, wherein the second grouping unit is further configured to add the target playing device to the target group according to the grouping permit command.

14. The terminal of claim 8, further comprising:
a second receiving unit, configured to receive a display command for displaying the playing device list, before the grouping command is received by the first receiving unit;
a searching unit, configured to search playing devices within a network; and
a displaying unit, configured to respond to the display command and display searched playing devices in the playing device list according to a first working state of each of the searched playing devices, wherein the detecting unit is further configured to detect the first working state of each of the searched playing devices.

15. An apparatus, comprising:
one or more processors; and
a memory comprising program codes, wherein when executed by the one or more processors, the program codes are adapted to cause the one or more processors to execute the following program units:
a first receiving unit, configured to receive a grouping command for adding a target playing device to a target group;
a first detecting unit, configured to respond to the grouping command and detect a working state of the target playing device; and
a grouping unit, configured to add the target playing device to the target group according to the working state.

16. The apparatus of claim 15, wherein the program codes are further adapted to cause the one or more processors to execute the following program units when executed:
a second detecting unit, configured to detect whether a terminal is a control terminal that controls the target playing device to play, wherein the working state is a playing state.

17. The apparatus of claim 16, wherein the program codes are further adapted to cause the one or more processors to execute the following program units when executed:
a second sending unit, configured to send a grouping request to the control terminal to require adding the target playing device to the target group, when it is detected by the detecting unit that the terminal is not the control terminal; and
a second receiving unit, configured to receive a grouping permit command sent by the control terminal in response to the grouping request.

18. The apparatus of claim 15, wherein the program codes are further adapted to cause the one or more processors to execute the following program units when executed:
a first sending unit, configured to send a connection request to the target playing device;
a first receiving unit, configured to receive a connection permit command sent by the target playing device in response to the connection request; and
a connecting unit, configured to establish a connection with the target playing device according to the connection permit command, wherein the working state is a disconnection state.

19. The apparatus of claim 15, wherein the program codes are further adapted to cause the one or more processors to execute the following program units when executed:
a third receiving unit, configured to receive a display command for displaying a playing device list, before the grouping command is received by the first receiving unit;
a searching unit, configured to search playing devices within a network; and
a displaying unit, configured to respond to the display command and display searched playing devices in the playing device list according to a first working state of each of the searched playing devices, wherein the detecting unit is further configured to detect the first working state of each of the searched playing devices.
